(19) United States
(12) Patent Application Publication
(10) Pub. No.: US 2025/0251993 A1
(43) Pub. Date: Aug. 7, 2025

(54) SHARED RESOURCE MANAGEMENT FOR MULTI-CORE SYSTEM

(71) Applicant: TEXAS INSTRUMENTS INCORPORATED, Dallas, TX (US)

(72) Inventors: Joseph D. ARONSON, Dallas, TX (US); Denis R. BEAUDOIN, Rowlett, TX (US); Peijun HOU, Garland, TX (US)

(21) Appl. No.: 18/981,503

(22) Filed: Dec. 14, 2024

Related U.S. Application Data
(60) Provisional application No. 63/550,449, filed on Feb. 6, 2024.
(60) Provisional application No. 63/550,209, filed on Feb. 6, 2024.
(60) Provisional application No. 63/550,156, filed on Feb. 6, 2024.

(51) Int. Cl. G06F 9/52

(52) U.S. Cl. CPC G06F 9/526

(57) ABSTRACT

In some examples, a circuit includes a shared resource and a semaphore manager. The semaphore manager is configured to manage access to the shared resource by, responsive to a first computing resource writing to a last pointer allocated to the first computing resource, determining whether the first computing resource has a dependency on a second computing resource that has been granted access to the shared resource, responsive to the first computing resource not having a dependency on the second computing resource, granting access by the first computing resource to the shared resource, and responsive to the first computing resource having the dependency on the second computing resource, denying access by the first computing resource to the shared resource. A spare pointer of the shared resources references a memory address of the shared resource.

### CROSS-REFERENCE TO RELATED APPLICATIONS

The present application claims priority to U.S. Provisional Patent Applications No. 63/550,449, which was filed Feb. 6, 2024, is titled “SEMAPHORE LOCK MANAGER,” U.S. Provisional Patent Application No. 63/550,209, which was filed Feb. 6, 2024, is titled “MEMORY MANAGER,” and U.S. Provisional Patent Application No. 63/550,156, which was filed Feb. 6, 2024, is titled “PRIORITY MANAGER,” each of which is incorporated herein by reference in its entirety.

### BACKGROUND

Some systems include resources, such as memory, that may be accessed or shared by multiple computing resources. In some implementations, challenges can arise in maintaining coherency of the memory or otherwise regulating or controlling access to the memory, or portions of the memory, by the computing resources.

### SUMMARY

In some examples, a circuit includes a shared resource and a semaphore manager. The semaphore manager is configured to manage access to the shared resource by, responsive to a first computing resource writing to a last pointer allocated to the first computing resource, determining whether the first computing resource has a dependency on a second computing resource that has been granted access to the shared resource. A spare pointer of the shared resources references a memory address of the shared resource. The semaphore manager is further configured to manage access to the shared resource by, responsive to the first computing resource not having a dependency on the second computing resource, granting access by the first computing resource to the shared resource. The semaphore manager is further configured to manage access to the shared resource by, responsive to the first computing resource having the dependency on the second computing resource, denying access by the first computing resource to the shared resource.

In some examples, a method includes determining dependencies between a first computing resource and a plurality of computing resources, responsive to a request from the first computing resource to access a shared resource, determining whether the first computing resource has a dependency on a second computing resource of the plurality of computing resources that has been granted access to write to the shared resource, responsive to the first computing resource not having a dependency on the second computing resource, granting access by the first computing resource to write to the shared resource, and responsive to the first computing resource having the dependency on the second computing resource, denying access by the first computing resource to the shared resource.

### BRIEF DESCRIPTION OF THE DRAWINGS

FIG. 1 is a block diagram of an example system.

FIG. 2 is a block diagram of an example memory manager.

FIG. 3 is a block diagram of an example memory allocation register.

FIG. 4 is a block diagram of an example OR-reduction operation.

FIG. 5 is a block diagram of an example encoder.

FIGS. 6A and 6B are timing diagrams of operation of an example memory manager.

FIG. 7 is a flowchart of an example method of memory management.

FIG. 8 is a block diagram of an example semaphore.

FIG. 9 is a flowchart of an example method of memory management.

FIG. 10 is a flowchart of an example method of memory management.

### DETAILED DESCRIPTION

As described above, some systems include resources, such as memory, that may be accessed or shared by multiple computing resources. In some implementations, challenges can arise in maintaining coherency of the memory or otherwise regulating or controlling access to the memory, or portions of the memory, by the computing resources. For example, a memory manager may manage allocating, using, and freeing blocks of memory. The memory manager may receive and act on allocation and free requests, monitor/check and update a memory management system, and return memory pointers, among other operations. A memory pointer is a variable, object, or other data structure that stores a memory address for a memory. Thus, by writing to a memory pointer, data is written to a memory to which the memory pointer corresponds and at an address of that memory as indicated in the memory pointer. Similarly, by reading from a memory pointer, data is read from a memory to which the memory pointer corresponds and at an address of that memory as indicated in the memory pointer.

In some systems of certain application environments, it may be useful to the systems for memory management operations to be performed rapidly, such as in digital networking or other systems. Software solutions to memory management may be suitable for some application environments. However, software solutions may not be as suited to application environments which include embedded hardware systems having hardware that makes requests to a same managing entity as firmware/software. In contrast, an implementation specific hardware-based memory manager may be useful with respect to improving memory efficiency and performance metrics, as well as reducing chip area and power consumption over those of software solutions. Though, the implementation specific hardware-based may lack the flexibility of software solutions and the ability to work with firmware/software entities.

Examples of this description provide for a hardware memory manager suitable for servicing memory allocation and free requests from hardware or software sources. The memory manager maintains coherency of the memory by including an interface through which all requests are funneled, thereby permitting servicing of a single request at a time. In an example, the memory manager groups the memory into N-byte blocks, where N may be any suitable whole number greater than zero. Each block may be represented by a single bit in a memory allocation register maintained by the memory manager, such as for indicating the block as allocated or free. For example, responsive to receipt of a memory allocation or free request, the memory manager may update the memory allocation register by setting (e.g., writing as having a value of digital “1”) a bit of the memory allocation register corresponding to a block that is allocated or clearing (e.g., writing as having a value of digital “0”, which may also be referred to as unsetting) a bit of the memory allocation register corresponding to a block that is freed. After updating the memory allocation register, the hardware memory manager calculates memory pointers of various sizes indicating available blocks, or groups of blocks, of free space in the memory. For example, the memory manager may perform an OR reduction of the bits of the memory allocation register through an OR tree to determine free block groups. In some examples, the block groups are split into power of 2 ranges (e.g., 1, 2, 3-4, 5-8, etc.). The memory manager may calculate memory pointers for each block group/range. In some examples, the memory manager calculates the memory pointers in a multi-phase process. In some examples, the multi-phase process may include a coarse phase and a fine phase. For example, the memory manager may first perform a coarse calculation in which the memory manager calculates memory pointers for each set of two block groups/ranges, treating each pair of block groups/ranges as a single group/range. Second, the memory manager may calculate memory pointers for the smaller sized block grouping of each pair of block groups/ranges having memory pointers calculated in the coarse phase calculation. In an example, the dynamic multi-phase memory pointer calculation process enables reuse of memory pointer encoding logic through time multiplexing, increasing efficiency of the memory manager in terms of both speed of operation and physical space (e.g., die surface area) consumed. This process may be especially beneficial in network processing environments in which packets must be allocated, processed, and freed at wire rates.

Responsive to receiving a memory allocation request, the memory manager returns a memory pointer calculated to have a maximum number of blocks for the range which includes the allocated blocks. For example, if the memory allocation request includes a request for allocation of six blocks, which belongs to the block group or range of 5-8, the memory manager may return a memory pointer for a portion of the memory having eight consecutive free blocks available. While memory managers may often by used dynamically, such as at system runtime, the memory manager herein may also include functionality to pre-allocate memory. For example, bits of the memory allocation register may be set to reserve space in the memory for software structures in the system, such as central processing unit (CPU) stacks, global variables/parameters, shared data structures, etc., or for preventing management of out-of-bound memory blocks due to a non-power-of-2 memory size.

As described above, shared data structures (e.g., shared memory resources) may exist in the system. These shared data structures may present their own unique management challenges, such as managing which of multiple computing resources are allowed to access a shared data structure, or a particular portion of a shared data structure, at a given time. For example, to maintain data coherency of the shared data structures, a semaphore may grant or deny access by a computing resource to the shared data structure. For example, a computing resource may request access to the shared data structure, such as by writing to a particular or predefined pointer allocated to the computing resource (e.g., a last pointer of the computing resource). Responsive to the request, the semaphore may determine whether to grant or deny the request. For example, the semaphore may determine whether another computing resource has received a lock (e.g., been granted access to) a shared resource that is the subject of a current request from a computing resource. Responsive to determining that another computing resource currently has a lock on the shared resource, the semaphore may deny the request from the current computing resource until the shared resource is released by the resource to which the lock has already been granted. Responsive to determining that no other computing resource currently has a lock on the shared resource, the semaphore may grant the request from the current computing resource, providing a lock on the shared resource that permits the current computing resource to utilize the shared resource.

Similar to the above, software implementations for semaphores may face certain challenges, such as slower performance, but may offer greater flexibility than some hardware semaphore implementations. Examples of this description also provide for a hardware-based semaphore that enables computing resources to request and, conditionally, be granted access to shared resources. In an example, a configured number of shared resources, which may be referred to as spares, may be provided in a system. Responsive to a computing resource writing to its last pointer, the semaphore determines whether or not to grant access by the computing resource to one of the shares resources. For example, the semaphore may determine dependencies among computing resources of the system and/or the shared resources. Based on these dependencies, the semaphore determines whether or not to grant access (e.g., a lock) to a requesting computing resource for a shared resource. In some examples, the requesting computing resource polls a lock status register to determine whether it has been granted access to a shared resource, and if so, to which shared resource, or portion of a shared resource, it has been granted access.

In various examples, the semaphore may provide various functionality related to managing the locks. For example, the semaphore may perform spare overflow detection in which, responsive to a computing resource attempting to write to a shared resource when all shared resources are in use, the semaphore requires the computing resource must read its spare overflow status and rewrite all of its spare and last resources to trigger the lock request. The semaphore may also enable clearing of a lock request prior to the lock request being granted, such as responsive to a software timeout mechanism when the lock is not granted prior to the timeout. In other examples, for single resource lock requests, a computing resource may change the requested resource prior to the semaphore granting the lock, and the semaphore may manage an order of granting single resource lock requests.

In some examples, the memory manager and the semaphore of this description are implemented in a same system, such that they operate in a complementary manner. For example, the memory manager may pre-allocate, or otherwise allocate, a shared data structure in a memory and the semaphore may subsequently control access to that shared data structure by granting, denying, and/or clearing locks for the shared data structure (or portions thereof) responsive to received requests for access to the shared data structure. In other examples, the system may include the memory manager of this description or the semaphore of this description without including the other. However, in such examples the system may also include a semaphore or a memory manager, respectively, implemented in a manner other than provided for herein. In still other examples, a system may include both the memory manager of this description or the semaphore of this description, but the memory manager and the semaphore may function substantially independently of one another.

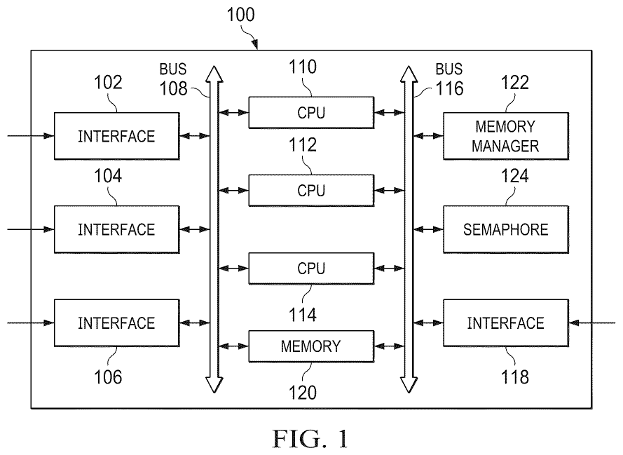

FIG. 1 is a block diagram of an example system 100. The system 100 may be generally representative of any computing device, or system that includes a computing device, such as a transportation vehicle (e.g., personal or commercial vehicle, aircraft, boat, train, etc.), industrial equipment, or the like. While certain components are shown in FIG. 1 as included in the system 100, in various examples the system 100 may include other components not shown in FIG. 1, the scope of which is not limited herein.

In an example, the system 100 includes an interface 102, an interface 104, an interface 106, a bus 108, a CPU 110, a CPU 112, a CPU 114, a bus 116, an interface 118, a memory 120, a memory manager 122, and a semaphore 124 (which may also be referred to as a semaphore manager). In an example, the interfaces 102, 104, 106, 118 may each be any suitable interface that facilitates communication, such as memory mapped registers (MMRs), packet receivers, transmitters, and/or transceivers, or the like, the scope of which is not limited herein. However, the interface types are merely exemplary, and the interfaces 102, 104, 106, 118 may be implemented in any suitable manner allowing interaction between the system 100 and another system or component (not shown) communicatively coupled to the system 100. The bus 108 and the bus 116 may each be implemented as a switch central resource (SCR) which may be a bus fabric that connects communication initiators to targets of that communication. The bus fabric may generally function in a manner similar to a queue, receiving and arbitrating delivery of data. In some examples, the bus fabric implements a priority scheme for delivery of received data to at least some destinations. The priority scheme may be any suitable scheme, such as round-robin, first-in first-out, weighted priority, or the like. The bus 108 and the bus 116 may implement a priority scheme for inbound and outbound communication, such as first-in, first-out (FIFO), round robin, weighted, fixed, or any other suitable priority scheme, the scope of which is not limited herein.

While three CPUs are shown in FIG. 1 (e.g., the CPUs 110, 112, 114), more or fewer CPUs may be present in the system 100 and the CPUs may be of any suitable architecture, such as reduced instruction set computing (RISC), RISC-V, Advanced RISC Machines (ARM), or the like, the scope of which is not limited herein. CPUs 110, 112, and 114 may include one or more processors. CPUs 110, 112, and 114, memory manager 122, and semaphore 124 may include any combination of integrated circuitry, discrete logic circuitry, analog circuitry, such as one or more microprocessors, microcontrollers, digital signal processors, application specific integrated circuits, central processing units, graphics processing units, field-programmable gate arrays, and/or any other processing resources. In some examples, CPUs 110, 112, and 114, memory manager 122, and semaphore 124 may include multiple components, such as any combination of the processing resources listed above, as well as other discrete or integrated logic circuitry, and/or analog circuitry.

In an example architecture, the interfaces 102, 104, 106 are each bi-directionally coupled to the bus 108, the CPUs 110, 112, 114 and the memory 120 are each bi-directionally coupled to the bus 108 and to the bus 116, the interface 118 is bi-directionally coupled to the bus 116, the memory manager 122 is bi-directionally coupled to the bus 116, and the semaphore 124 is bi-directionally coupled to the bus 116.

In an example, the system 100 may receive a memory allocation request for the memory 120 via any one or more of the interfaces 102, 104, 106, 118 and may provide the request(s) to the memory manager 122. In some examples, one or more of the CPUs 110, 112, 114 may generate a memory allocation request for the memory 120 and provide the request(s) to the memory manager 122. Responsive to the memory allocation request, or alternatively to a memory free request, the memory manager 122 may perform a memory allocation, or memory free, operation as described elsewhere herein. Memory 120 may include random access memory (RAM), read-only memory (ROM), flash memory, a solid-state drive, magnetic media, optical media, or any other computer readable storage devices or tangible computer readable media.

In an example, one or more of the CPUs 110, 112, 114 may request access to a shared portion of the memory 120. In some examples, the request is received, or detected, by the semaphore 124. Responsive to the request, the semaphore 124 may determine whether to grant access to the shared portion of the memory 120 to the requesting CPU and, in some examples, grant or deny access to the shared portion of the memory 120 to the requesting CPU as described elsewhere herein.

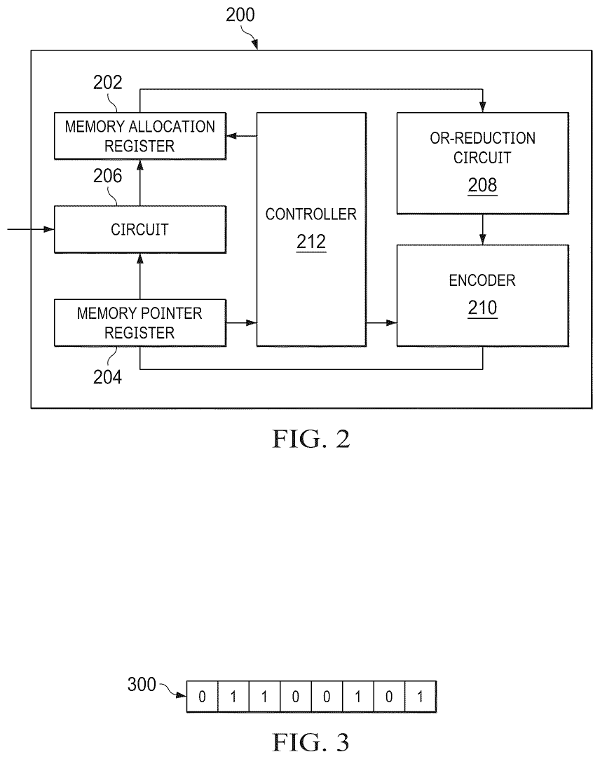

FIG. 2 is a block diagram of an example memory manager 200. In at least some examples, the memory manager 200 is suitable for implementation as the memory manager 122 of FIG. 1. In an example, the memory manager 200 manages a memory, such as the memory 120, such that memory allocation operations and memory free operations for the memory are performed by the memory manager 200. In this way, the memory manager 200 may provide data coherency for the memory such that operation of the memory is not adversely affected by multiple hardware, firmware, and/or software components interacting with the memory.

In an example, the memory manager 200 includes a memory allocation register 202, a memory pointer register 204, a circuit 206, an OR-reduction circuit 208, an encoder 210, and a controller 212 (which may also be referred to as a logic circuit). The memory allocation register 202 and memory pointer register 204 may each be implemented according to any suitable hardware architecture, the scope of which is not limited here. The circuit 206 includes registers and one or more logic circuits for interacting with the registers, such as for decoding information received by the memory manager 200 (e.g., from the bus 108 or bus 116, providing data to the bus 108 or bus 116, interfacing with the controller 212, and the like. The OR-reduction circuit 208 includes logic circuits suitable for performing logical operations, such as logical shift operations, logical OR operations, or the like. The encoder 210 includes components suitable for encoding memory pointers based on the data of the memory allocation register 202, as represented in an output of the OR-reduction circuit 208. For example, the encoder 210 may, for each group of blocks formed by the memory manager 200, determine a lowest addressed block available for each respective group. For example, for a block group of 5-8, indicating that a memory pointer corresponding to that block group will provide 8 consecutive free blocks, the encoder 210 may determine an address of a lowest address block of the memory that is the first of 8 consecutive free blocks and may provide the address of that lowest address block as the memory pointer for block group 5-8. In an example, the controller 212 executes instructions, implements a state machine, or otherwise controls at least some other components of the memory manager 200 to perform various operations. For example, the controller 212 sets or clears bits in the memory allocation register 202 based on received memory allocation or memory free requests received by the memory manager 200 and controls the encoder 210 to identify the lowest addressed block available for each respective group. In various other examples, the controller 212 performs other operations in the memory manager 200, the scope of which is not limited herein.

In an example of operation of the memory manager 200, a request is received. In some examples, the request is received from a hardware device, such as a CPU. In other examples, the request is received from a peripheral device, such as via a communication interface. In other examples, the request is received from a firmware or software component. The request indicates a size of a requested memory allocation in blocks. In some examples, the request is, or includes, a read operation. For example, the requesting component may read the memory pointer register 204 to determine a memory pointer corresponding to the size of the requested memory allocation. For example, a memory may be divided into blocks, such as blocks of about 64 bytes. These blocks may then be combined into logical groups of consecutive blocks, such as groups of 1 block, 2 blocks, 4 blocks, 8 blocks, 16 blocks, 32 blocks, 64 blocks, etc. Each of these groups may have an associated memory pointer indicating a lowest addressed block in the memory at which the group of blocks begins. In some examples, such as when no memory allocations have been performed, memory pointers of each of the groups may have a same value, such as a value corresponding to a memory address of 0.

Each of the groups may be represented by a memory pointer, and each memory pointer may be stored at a predefined or programmed location in the memory pointer register 204. For example, to obtain an allocation of 1 block, the requesting component may read the location of the memory pointer register 204 corresponding to the memory pointer for 1 block. Similarly, to obtain an allocation of 5 blocks, the requesting component may read the location of the memory pointer register 204 corresponding to 8 blocks, because the 8-block group is the smallest group that can service a 5-block allocation request. Still further, to obtain an allocation of 47 blocks, the requesting component may read the location of the memory pointer register 204 corresponding to 64 blocks, because the 64-block group is the smallest group that can service a 47-block allocation request. Based on the read memory pointer, the requesting component obtains an address of the memory (e.g., the memory pointer) at which the requesting component may begin writing to the memory.

The controller 212 may read the request received from the requesting component to determine the size of the requested memory allocation, and may read the memory pointer register 204 to obtain the memory pointer returned to the requesting component. Based on the memory pointer and the size of the requested memory allocation, the controller 212 updates the memory allocation register 202. In some examples, the memory allocation register 202 may be referred to as an allocation state bit table, or may store an allocation state bit table. For example, beginning with a data bit (e.g., an allocation state bit) of the memory allocation register 202 corresponding to a block of the memory beginning at the memory address identified by the memory pointer, and continuing for a number of data bits equaling the size (e.g., number of blocks) of the requested memory allocation, the controller 212 sets the bits of the memory allocation register 202. In this way, the controller 212 updates the memory allocation register 202 to reflect the memory allocation performed to the requesting component.

After updating the memory allocation register 202 to reflect a current state of allocations in the memory, the memory manager 200 recalculates the memory pointers and stores the recalculated memory pointers in the memory pointer register 204. In some examples, the recalculation is performed in a multi-phase approach, such as a coarse determination and a fine determination. The coarse determination may pair the block groups. For example, the memory manager 200 may recalculate memory pointers for block groups 1 and 2, block groups 4 and 8, block groups 16 and 32, and block group 64 as a part of the coarse, or first phase, memory pointer recalculation. This recalculation may consume approximately 4 clock cycles worth of time. The memory manager 200 may then perform the fine determination to obtain memory pointers for the smaller sized block grouping of each pair of block groups having memory pointers calculated in the first-phase recalculation. For example, the memory manager 200 may recalculate memory pointers for block group 1, block group 4, and block group 16 as a part of the fine, or second phase, memory pointer recalculation. Each of these recalculated memory pointers may be stored to the memory pointer register 204 for subsequent reads by requesting components. In an example, the memory manager 200 may be ready to service a subsequent memory allocation request in about 4 clock cycles (e.g., after completion of the first phase of the memory pointer recalculation). The second phase of the memory pointer recalculation may consume approximately 2 additional clock cycles worth of time after completion of the first phase of the memory pointer recalculation.

In an example, to perform the memory pointer recalculation, the OR-reduction circuit 208 OR reduces the data bits of the memory allocation register 202. For example, the OR-reduction circuit 208 may perform 2-bit OR reducing of the allocation state bits by OR-reducing the allocation state bits in a binary tree. The following example assume a 64-block system, as described herein. However, other block size systems may be implemented, and this description is extendable to those implementations. For example, the OR-reduction circuit 208 performs an OR operation between the data bits of the memory allocation register (e.g., block 1) and block 1 having undergone a left-shift operation by 1 block width. A result of the OR operation is block 2. The OR-reduction circuit 208 next performs an OR operation between block 2 and block 2 having undergone a left-shift operation by 1 block width. A result of this OR operation is block 3. The OR-reduction circuit 208 next performs an OR operation between block 3 and block 3 having undergone a left-shift operation by 1 block width. A result of this OR operation is block 4. The OR-reduction circuit 208 next performs an OR operation between block 4 and block 4 having undergone a left-shift operation by 4 block widths. A result of this OR operation is block 8. The OR-reduction circuit 208 next performs an OR operation between block 8 and block 8 having undergone a left-shift operation by 8 block widths. A result of this OR operation is block 16. The OR-reduction circuit 208 next performs an OR operation between block 16 and block 16 having undergone a left-shift operation by 16 block widths. A result of this OR operation is block 32. The OR-reduction circuit 208 next performs an OR operation between block 16 and block 32. A result of this OR operation is block 48. The OR-reduction circuit 208 next performs an OR operation between block 32 and block 32 having undergone a left-shift operation by 32 block widths. A result of this OR operation is block 64.

Based on the calculated blocks, the encoder 210 determines the updated memory pointers. In an example, block 1 is representative of 1 block of the memory, block 2 is representative of a group of 2 consecutive blocks of the memory, block 4 is representative of 4 consecutive blocks of the memory, block 8 is representative of 8 consecutive blocks of the memory, block 16 is representative of 16 consecutive blocks of the memory, block 32 is representative of 32 consecutive blocks of the memory, block 48 is representative of 48 consecutive blocks of the memory, and block 64 is representative of 64 consecutive blocks of the memory. In the coarse determination, the encoder 210, under control of the controller 212, determines a least significant bit of each of block 2, block 8, block 32, and block 64 that has a value of zero, indicating that block is free. The memory address of the memory block corresponding to the least significant bit of block 2 having a value of zero may be the memory pointer for block 1 and block 2 at the coarse determination. Similarly at the coarse determination, the memory address of the memory block corresponding to the least significant bit of block 8 having a value of zero may be the memory pointer for block 4 and block 8, the memory address of the memory block corresponding to the least significant bit of block 32 having a value of zero may be the memory pointer for block 16 and block 32, and the memory address of the memory block corresponding to the least significant bit of block 64 having a value of zero may be the memory pointer for block 48 and block 64.

In the fine determination, the encoder 210 determines a least significant bit of each of block 1, block 4, block 16, and block 48 that has a value of zero, indicating that block is free. The memory address of the memory block corresponding to the least significant bit of block 1 having a value of zero may be the memory pointer for block 1 at the fine determination. Similarly at the fine determination, the memory address of the memory block corresponding to the least significant bit of block 4 having a value of zero may be the memory pointer for block 4, the memory address of the memory block corresponding to the least significant bit of block 16 having a value of zero may be the memory pointer for block 16, and the memory address of the memory block corresponding to the least significant bit of block 48 having a value of zero may be the memory pointer for block 48. The determined memory pointers as calculated by the encoder 210 for each free block determined as the start of a block group may be stored in the memory pointer register 204 to enable servicing by the memory manager 200 of a subsequent memory allocation request.

Illustrating the above, the following Table 1 shows a mapping of block groups (e.g., a number of contiguous free blocks) to a number of blocks required for each phase of the memory pointer calculation and a block alignment in each phase of the memory pointer calculation. In an example, the encoder 210 determines or calculates a memory pointer (ptr[x]) for each block group (e.g., 8 block groups as shown in Table 1), storing the determined memory pointers in the memory pointer register 204. Each of the block groups may be an individually addressable group of memory blocks, identified by respective memory pointers. As described elsewhere herein, the memory pointer calculation may be performed in two phases, a coarse and a fine calculation (e.g., phase 1 and phase 2) such that ptr[2], ptr [4], ptr[6], and ptr[8] are determined in the phase 1 calculation and ptr[1], ptr [3], ptr[5], and ptr[7] are determined in the phase 2 calculation. Thus, because ptr[2] is for block group 2, two consecutive free blocks are required to determined ptr[2](as indicated by “Phase 1 Blocks”). Similarly, because ptr[4] is for block group 5-8, eight consecutive free blocks are required to determined ptr[4], and so forth for other phase 1 memory pointer calculations. Additionally, because ptr[1] is for block group 1, one consecutive free block is required to determined ptr[1], and so forth for other phase 2 memory pointer calculations (as indicated by “Phase 2 Blocks”). After the phase 1 memory pointer calculation, a smallest quantity of memory blocks that may be allocated in a given block group is indicated by “Phase 1 Alignment.” Similarly, after the phase 2 memory pointer calculation, a smallest quantity of memory blocks that may be allocated in a given block group is indicated by “Phase 2 Alignment.”

TABLE 1

| | | Phase 1 | Phase 1 | Phase 2 | Phase 2 |
|---|---|---|---|---|---|
| Pointer | Block Group | Blocks | Alignment | Blocks | Alignment |
| ptr[1] | 1 | 2 | 1 | 1 | 1 |
| ptr[2] | 2 | 2 | 1 | n/a | n/a |
| ptr[3] | 3-4 | 8 | 2 | 4 | 1 |
| ptr[4] | 5-8 | 8 | 2 | n/a | n/a |
| ptr[5] | 9-16 | 32 | 8 | 16 | 4 |
| ptr[6] | 17-32 | 32 | 8 | n/a | n/a |
| ptr[7] | 33-48 | 64 | 16 | 48 | 8 |
| ptr[8] | 49-64 | 64 | 16 | n/s | n/a |

In some examples, the memory manager 200 may also receive a free memory request. The free memory request may be a request from the requesting component to release or de-allocate memory blocks previously allocated to the requesting component. For example, the requesting component may provide a free memory request including a memory address and an allocation size to be freed beginning at the provided memory address. The circuit 206 may decode the received memory address and allocation size and clear bits in the memory allocation register 202 beginning at a block corresponding to the received memory address and continuing for a number of consecutive blocks as indicated in the received allocation size to be freed. Subsequent to updating the memory allocation register 202 by clearing bits of the memory allocation register 202, the memory manager 200 may recalculate or update the pointers stored in the stored in the memory pointer register 204, as described elsewhere herein.

FIG. 3 is a block diagram of an example memory allocation register 300. In an example, the memory allocation register 300 is suitable for implementation as the memory allocation register 202 of FIG. 2. In some examples, the memory allocation register 300 may be stored by one or more storage devices, such as an array of digital-flops (e.g., d-flip flops) each configured to store one respective bit of data, such as one respective allocation state bit, an array of memory cells, such as NAND memory cells, or the like, the scope of which is not limited herein. In an example, the memory allocation register 300 is suitable for storing multiple bits of data. As described above, in some examples, each bit of the memory allocation register 300 uniquely corresponds to a block of a memory, such as the memory 120 of FIG. 1. As such, an allocation status of each respective block of the memory is representable in the memory allocation register 300. For example, for a memory block represented in the memory allocation register 300 by a particular data bit, the bit having a value of digital “1” indicates that the memory block is allocated and the bit having a value of digital “0” indicates that the memory block is free. Although eight bits are shown in the memory allocation register 300, in application any suitable number of bits may be included in the memory allocation register 300. Additionally, while certain allocation and free statuses (e.g., values of digital “1” or “0,” respectively) are shown in FIG. 3, these statuses are merely exemplary and do not limit the memory allocation register 300.

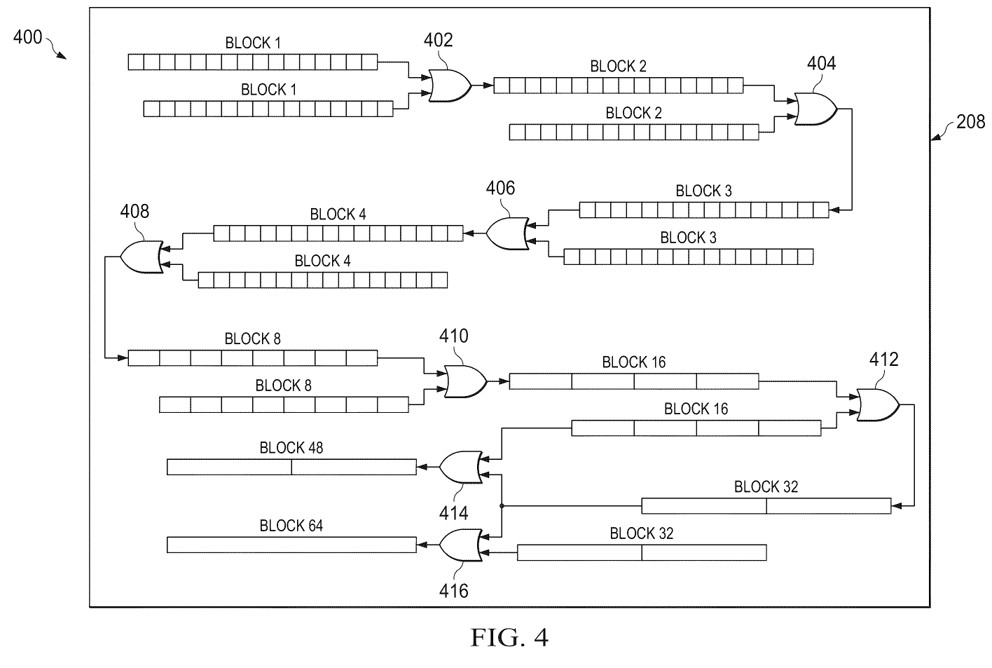

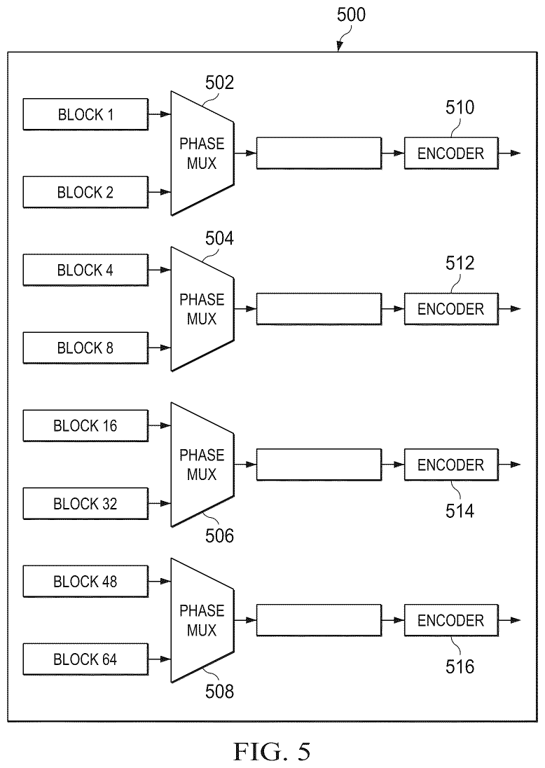

FIG. 4 is a block diagram 400 of an example OR-reduction operation. In an example, the OR-reduction operation of the diagram 400 is representative of operation of the OR-reduction circuit 208 of the memory manager 200 of FIG. 2, as described above. In an example, the OR-reduction operation is performed by processing ranges of blocks of the memory 120 via OR logic circuits. In some examples, the OR logic circuits are implemented as discrete components, such as one or more arrays of OR logic gates. In other examples, the OR logic circuits are implemented via programmable logic circuits, such as a field programmable gate array (FPGA). In an example, an OR logic array 402 performs an OR operation between the data bits of the memory allocation register 204 (e.g., block 1) and block 1 having undergone a left-shift operation by 1 block width. A result of the OR operation is block 2. An OR logic array 404 next performs an OR operation between block 2 and block 2 having undergone a left-shift operation by 1 block width. A result of this OR operation is block 3. An OR logic array 406 next performs an OR operation between block 3 and block 3 having undergone a left-shift operation by 1 block width. A result of this OR operation is block 4. An OR logic array 408 next performs an OR operation between block 4 and block 4 having undergone a left-shift operation by 4 block widths. A result of this OR operation is block 8. An OR logic array 410 next performs an OR operation between block 8 and block 8 having undergone a left-shift operation by 8 block widths. A result of this OR operation is block 16. An OR logic array 412 next performs an OR operation between block 16 and block 16 having undergone a left-shift operation by 16 block widths. A result of this OR operation is block 32. An OR logic array 414 next performs an OR operation between block 16 and block 32. A result of this OR operation is block 48. An OR logic array 416 next performs an OR operation between block 32 and block 32 having undergone a left-shift operation by 32 block widths. A result of this OR operation is block 64.

In an example, each of the OR logic arrays 402, 404, 406, 408, 410, 412, 414, 416 may have a number of OR logic gates equal to a number of data bits in a respective block of the data bits of the memory allocation register 204 which are being processed by that OR logic array.

FIG. 5 is a block diagram of an example encoder 500. In an example, the encoder 500 is suitable for implementation as the encoder 210 of FIG. 2 and receives the blocks calculated by the OR-reduction circuit 208, as described above. As shown in FIG. 5, the encoder 500 includes multiplexers 502, 504, 506, 508, as well as encoder circuits 510, 512, 514, and 516. The multiplexer 502 receives block 1 at first input and block 2 at a second input. An output of the multiplexer 502 is coupled to an input of the encoder circuit 510. The multiplexer 504 receives block 4 at first input and block 8 at a second input. An output of the multiplexer 504 is coupled to an input of the encoder circuit 512. The multiplexer 506 receives block 16 at first input and block 32 at a second input. An output of the multiplexer 506 is coupled to an input of the encoder circuit 514. The multiplexer 508 receives block 48 at first input and block 64 at a second input. An output of the multiplexer 508 is coupled to an input of the encoder circuit 516.

Each of the encoder circuits 510, 512, 514, and 516 searches a received block for a least significant bit of the received block having a value of logic 0. For example, each encoder circuit 510, 512, 514, and 516 may include a multiplexer having a number of inputs equal to a maximum number of bits that may be in a received block. The controller 212 provides respective control signals to each of the encoder circuits 510, 512, 514, and 516 to progressively select a next more significant bit, beginning with a least significant bit, of a block received by the respective encoder circuits 510, 512, 514, 516, thereby causing the multiplexer of the encoder circuit to provide a value of a selected bit as an output signal of that multiplexer. Each encoder circuit 510, 512, 514, and 516 may include a comparator to compare the output of the multiplexer of the encoder circuit 510, 512, 514, and 516 to a value of logical 0. Responsive to determining that the output of the multiplexer has a value of logical 0, the comparator provides an output signal having a value of logical 1. In some examples, the comparator of a respective encoder circuit 510, 512, 514, 516 provides its output signal to the controller 212. Responsive to receiving a signal having a value of logical 1 from an encoder circuit 510, 512, 514, 516, the controller 212 determines a memory pointer for the block as a memory address of the memory 120 corresponding to a block for which the memory allocation bit is currently selected in the respective encoder circuit 510, 512, 514, 516 from which the controller 212 received the signal having the value of logical 1. In this way, the memory pointers are encoded (e.g., determined or calculated) based on the blocks calculated by the OR-reduction circuit 208, as described above, from the bits of the memory allocation register 202.

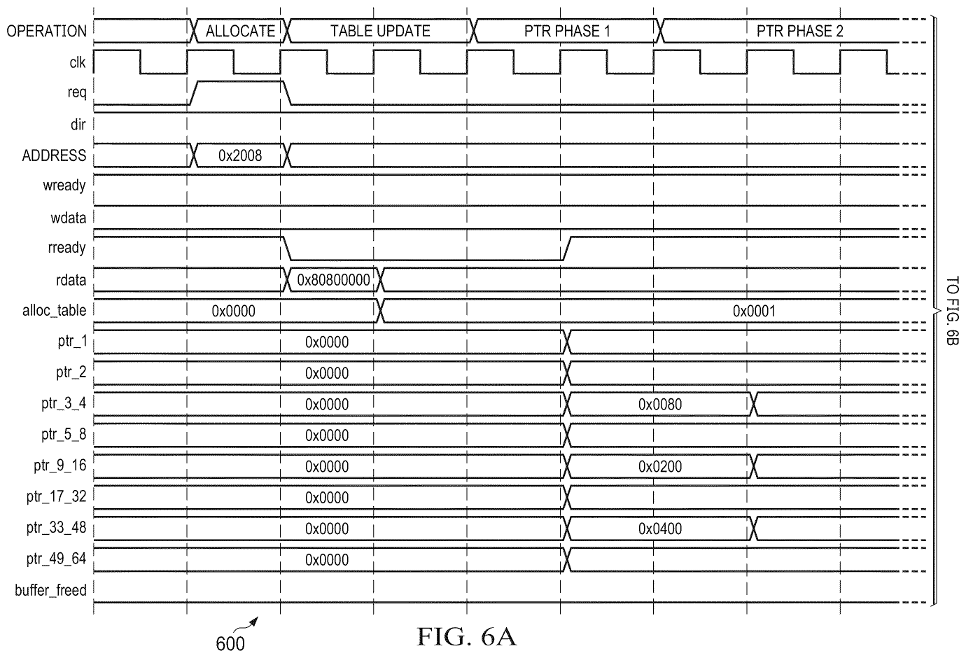

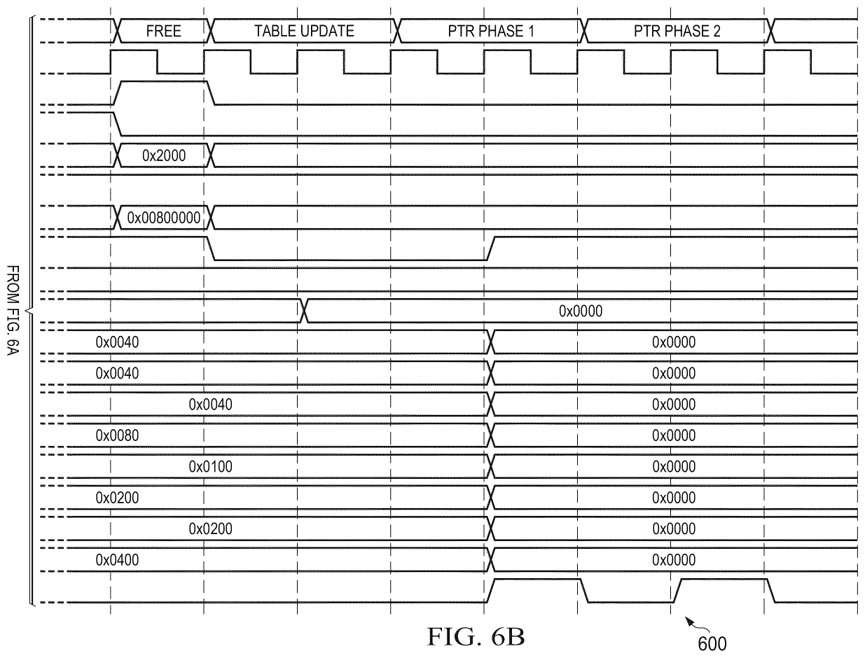

FIGS. 6A and 6B together form a timing diagram 600 of operation of an example memory manager. In some examples, the diagram 600 is representative of at least some signals in the system 100 of FIG. 1, such that the signals are representative of operation of the memory manager 122. The diagram 600 includes a clock signal (clk) which controls operation of the memory manager, a request signal (req) indicating that a request (e.g., an allocation request or a free request) has been received by the memory manager, a bus transaction direction signal (dir) indicating a bus transaction direction (e.g., 0 for write or 1 for read), an address signal (signal) indicating a value of the memory pointer read by the requesting component, a bus transaction write ready signal (wready) indicating that the memory manager is ready to accept a write transaction responsive to wready having a value of 1, a bus transaction write data signal (wdata), a bus transaction read ready signal (rready) indicating that the memory manager is ready to accept a read transaction responsive to rready having a value of 1, a bus transaction read data signal (rdata), a signal alloc_table indicating a value stored in the memory allocation register 202, a signal ptr_1 indicating a value of the memory pointer stored in the memory pointer register 204 for group 1, a signal ptr_2 indicating a value of the memory pointer stored in the memory pointer register 204 for group 2, a signal ptr_3_4 indicating a value of the memory pointer stored in the memory pointer register 204 for group 4, a signal ptr_5_8 indicating a value of the memory pointer stored in the memory pointer register 204 for group 8, a signal ptr_9_16 indicating a value of the memory pointer stored in the memory pointer register 204 for group 16, a signal ptr_17_32 indicating a value of the memory pointer stored in the memory pointer register 204 for group 32, a signal ptr_33_48 indicating a value of the memory pointer stored in the memory pointer register 204 for group 48, a signal ptr_49_64 indicating a value of the memory pointer stored in the memory pointer register 204 for group 64, and a signal freed indicating that a requested memory free operation has been successfully completed.

While certain values are shown for signals of the diagram 600, these signals are merely exemplary and are not intended to limit the scope of operation of the memory manager. The diagram 600 shows signals of the example memory manager responsive to a memory allocation request and a free memory request. As shown by the diagram 600, responsive to receipt of a memory allocation request, an address (in the example of FIG. 6A, 0x2008) is provided. In some examples, providing the address consumes approximately one clock cycle worth of time. Responsive to providing the address, a table update operation is performed in which the memory allocation register 202 is updated to reflect the memory allocation performed at the provided address. In some examples, performing the table update consumes approximately two clock cycles worth of time. After performing the table update, the multi-phase memory pointer update operation is performed beginning with phase 1 and followed by phase 2. Each of phase 1 and phase 2 consumes approximately two clock cycles worth of time. As such, from a time of the memory manager servicing a first memory allocation request to the memory manager being capable of, or ready to, service a second memory allocation request may be approximately 4 clock cycles (e.g., 2 clock cycles for performing the table update and 2 clock cycles for performing the phase 1 memory pointer update). As further shown by the diagram 600, responsive to receipt of a memory free request, a memory allocation is cleared. For example, the memory free request includes an address (in the example of FIG. 6B, 0x2000) at which a memory allocation to be cleared begins. Although not shown in FIG. 6B, the memory free request may also include a size of the allocation to be freed. Responsive to receiving the free memory request, a table update operation is performed in which the memory allocation register 202 is updated to reflect the freed memory beginning at the provided address and continuing for a number of blocks as indicated in the size of the allocation to be freed. Subsequently, memory pointers are recalculated, as described elsewhere herein.

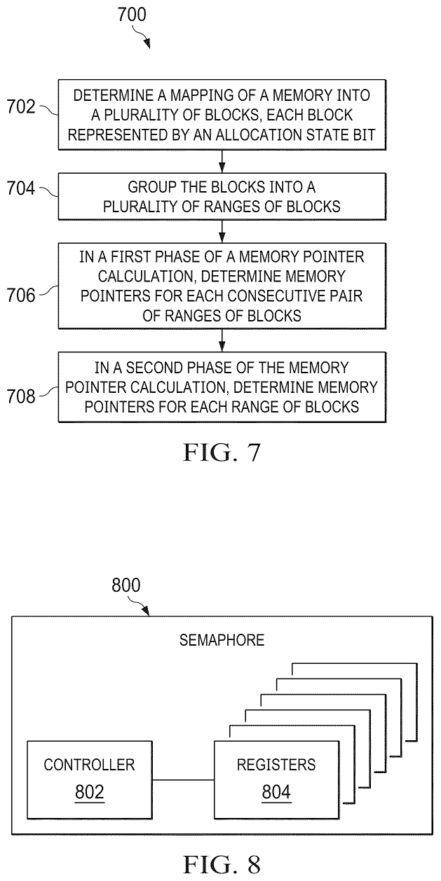

FIG. 7 is a flowchart of an example method 700 of memory management. In some examples, at least some portions of the method 700 are implemented by a memory manager, such as the memory manager 122 of FIG. 1 or 200 of FIG. 2. In an example, the method 700 is implemented to service memory allocation requests, calculate memory pointers for available groups of memory blocks, and service free memory requests, such as described above herein.

At operation 702, a mapping of a memory into a plurality of blocks, each block represented by an allocation state bit, is determined by the memory manager. In some examples, the memory is mapped into a plurality of blocks approximately 64 bytes in size. In other examples, the blocks have any other suitable size. In an example, each block may be uniquely addressable. Each block may also be represented by an allocation state bit in a register. The allocation state bit for a block may indicate whether that block is allocated or free.

At operation 704, the blocks are grouped into a plurality of ranges of blocks by the memory manager. In some implementations, the memory manager may group the blocks into ranges according to powers of 2, or according to any other scheme. In an example, the blocks may be grouped into ranges of 1, 2, 4, 8, 16, 32, 48, and 64 blocks. In this scheme, the memory manager may allocate or free up to 64 blocks responsive to a single request, such as in a single clock cycle.

At operation 706, in a first phase of a memory pointer calculation, memory pointers for each consecutive pair of ranges of blocks are determined by the memory manager. In some examples, the determining the memory pointers is performed responsive to performing an update of at least some allocation state bits (e.g., responsive to performance of a memory allocation or free memory operation). For example, responsive to an allocation operation being performed to a subset of the plurality of blocks of the memory, the memory manager may update allocation state bits of each block of the subset of the plurality of blocks to reflect an allocated state. The memory manager can store the allocation state bits in a register, in an array of digital flops, or in any other suitable data structure or storage device. Responsive to such updating, the memory pointer calculation may be performed by the memory manager.

In some examples, the memory pointers are determined by the memory manager performing 2-bit OR reducing of the allocation state bits. The OR reducing of the allocation state bits results in a plurality of blocks of allocation state bits. The results of the OR reduction may be representative of the ranges of blocks. Each consecutive pair of ranges of blocks may then be combined by the memory manager and the resulting combination may be searched in order from the least significant bit (LSB) to the most significant bit (MSB) for a first value of digital “0”. The value of digital “0” may indicate the first available free space in the pair of ranges of blocks. A memory address corresponding to the allocation state bit having the value of digital “0” may be the memory pointer for that respective pair of ranges of blocks. In some examples, the memory pointers calculated in the first phase of the memory pointer calculation may be stored by the memory manager in a memory pointer table. The memory pointer table may be stored in a register, in an array of digital flops, or in any other suitable data structure or storage device.

While described herein as being performed responsive to an allocation operation being performed, in some examples the memory pointer calculation is also performed by the memory manager in substantially the same manner as described herein responsive to allocation state bits being cleared in response to a free memory operation being performed.

At operation 708, in a second phase of the memory pointer calculation subsequent to the first phase, memory pointers for each range of blocks are determined by the memory manager. For example, the memory manager can search each smaller range of blocks from the prior combinations of ranges of blocks in order from the LSB to the MSB for a first value of digital “0”. The value of digital “0” may indicate the first available free space in the range of blocks. A memory address corresponding to the allocation state bit having the value of digital “0” may be the memory pointer for that range of blocks. In some examples, the memory pointers calculated in the second phase of the memory pointer calculation may be stored by the memory manager in the memory pointer table.

Although not shown in FIG. 7, in some examples, the method 700 also includes, responsive to receiving an allocation request from a requestor, the memory manager providing the requestor with a memory pointer determined in the first phase of the memory pointer calculation for a range of blocks that is unallocated. Similarly, although also not shown in FIG. 7, in some examples, the method 700 also includes the memory manager reserving a subset of the plurality of blocks in a pre-allocation operation by unlocking an allocation table in which the allocation state bits are stored, designating the subset of the plurality of blocks as allocated in the allocation table, and locking the allocation table.

FIG. 8 is a block diagram of an example semaphore 800. In at least some examples, the semaphore 800 is suitable for implementation as the memory semaphore 124 of FIG. 1. In an example, the semaphore 800 manages shared (or spare) resources, such as allocated in a memory, such as the memory 120. For example, the semaphore 800 manages the shared resources to grant or deny access to the shared resources to a computing resource requesting access to the shared resource(s). In this way, the semaphore 800 may provide data coherency for the shared resources such that operation of the shared resources is not adversely affected by computing resources interacting with the shared resources.

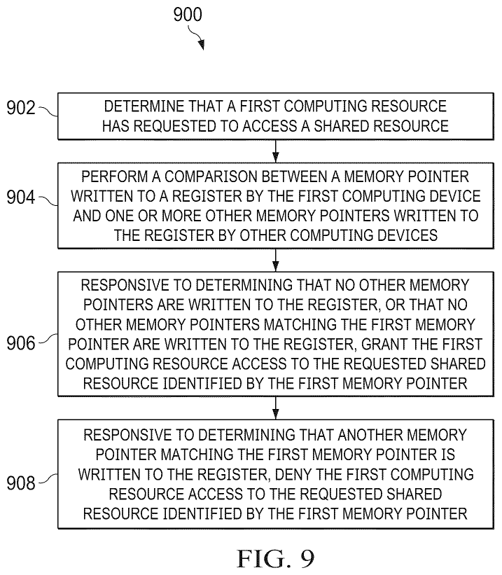

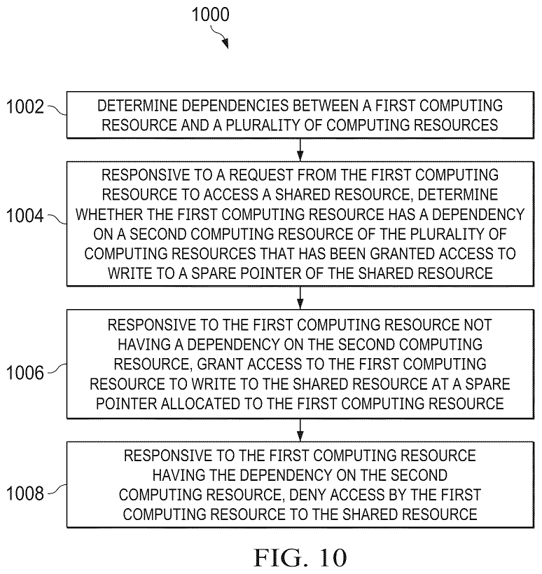

In an example, the semaphore 800 includes a controller 802 (which may also be referred to as a logic circuit) and registers 804. In various examples, any suitable number of registers may be included in the registers 804 to enable the semaphore 800 to perform at least the functions ascribed to it herein. The controller 802 may execute instructions, such as may be stored in a cache of the controller 802, one or more registers of the registers 804, or any other suitable memory location or storage device. By executing the instructions, the controller 802 implemented a memory management method, such as described below with respect to FIG. 9 and/or FIG. 10. For example, one or more computing devices (not shown) may write to one or more registers of the registers 804 to request or release access to a shared resource, the computing devices may read one or more registers of the registers 804 to determine whether a respective computing device has been granted access to a shared resource, the controller 802 may write to one or more registers of the registers 804 based on determinations made in determining whether to grant access by a requesting computing device to a shared resource, or the like. Operation of the semaphore 800 in granting or denying access by a requesting computing device to a shared resource may be further understood with reference to the following method 900 of FIG. 9 and method 1000 of FIG. 10.

FIG. 9 is a flowchart of an example method 900 of memory management. In some examples, at least some portions of the method 900 are implemented by a semaphore, such as the semaphore 124 of FIG. 1 or 800 of FIG. 8. In an example, the method 900 is implemented to grant or deny requests from computing resources (e.g., CPUs) for access to a shared (or spare) resource, such as a shared memory pool or multiple pools with various processes accessing different pools, as described above herein. For example, the method 900 may be implemented to grant or deny requests from computing resources for access to a shared resource when those computing resources have only one shared resource possibly available to them (e.g., single-resource requests).

At operation 902, a determination is made by a semaphore (e.g., a semaphore manager or semaphore circuit) that a first computing resource has requested to access a shared resource. For example, to request access to the shared resource (e.g., that the first computing resource be granted a lock on the shared resource, or exclusive write access for the shared resource for a period of time), the first computing resource writes to a register, such as a memory mapped register. In an example, the first computing resource writes a value for a first memory pointer (e.g., shared resource) to which the first computing resource is requesting access. In other examples, the first computing resource sets a bit of the register, such as a bit having a unique correspondence to both the first computing resource and the shared resource.

At operation 904, a comparison is performed between the first memory pointer written to the register by the first computing device and one or more other memory pointers written to the register by other computing devices, such as a second computing device.

At operation 906, responsive to determining that no other memory pointers are written to the register, or that no other memory pointers matching the first memory pointer are written to the register, the first computing resource is granted access to (e.g., a lock on) the requested shared resource identified by the first memory pointer. In some examples, the first computing device is granted access to the shared resource by the semaphore writing to a lock status register (or grant status register) a status of a grant of access to the shared resource for the first computing resource. The grant of access may be indicated by the semaphore setting a bit in a lock status register corresponding to the first computing resource and the shared resource to which the first computing resource has been granted access (e.g., given a lock). The writing may enable the first computing resource to poll the lock status register to determine whether the first computing resource has been granted access to the shared resource.

At operation 908, responsive to determining that another memory pointer matching the first memory pointer is written to the register, such as by the second computing device, the first computing resource is denied access to (e.g., a lock on) the requested shared resource identified by the first memory pointer. In some examples, responsive to denying access to the shared resource due to the shared resource currently being locked to the second computing device, the first computing device is placed, by the semaphore, in a queue or other priority order to receive access to the shared resource responsive to the shared resource no longer being locked to the second computing device. Responsive to the shared resource no longer being locked to the second computing device, the first computing device is granted access to the shared resource by writing to the lock status register as described above with respect to operation 906.

Although not shown in FIG. 9, in some examples, the method 900 also includes, responsive to the first computing resource clears its previous write (e.g., as described with respect to operation 902) to the register, releasing the shared resource (e.g., the memory pointer) allocated to the first computing resource. Although also not shown in FIG. 9, in some examples, the method 900 also includes, responsive to the first computing resource releasing the shared resource, the semaphore determining whether any other computing resource is eligible to receive access to the shared resource, such as another computing device in the queue to receive access to the shared resource, and, in some examples, granting access to the shared resource to a next computing device in the queue to receive access to the shared resource.

FIG. 10 is a flowchart of an example method 1000 of memory management. In some examples, at least some portions of the method 1000 are implemented by a semaphore, such as the semaphore 124 of FIG. 1 or 800 of FIG. 8. In an example, the method 1000 is implemented to grant or deny requests from computing resources (e.g., CPUs) for access to a shared (or spare) resource, such as a shared memory, as described above herein. For example, the method 1000 may be implemented to grant or deny requests from computing resources for access to a shared resource when those computing resources have multiple shared resources possibly available to them (e.g., multi-resource requests).

At operation 1002, dependencies between a first computing resource and a plurality of computing resources are determined by a semaphore circuit. In some examples, the semaphore determining the dependencies between the first computing resource and the plurality of computing resources is a multi-step process. For example, to determine dependencies between the first computing resource and the plurality of computing resources, the semaphore can set two-way dependencies between any pair of computing resources that have spare pointers in common, and setting a one-way dependency of the first computing resource on any other computing resource that has a last pointer matching a spare pointer of the first computing resource.

In some examples, to determine dependencies between the first computing resource and the plurality of computing resources, the semaphore can also set two-way dependencies between the first computing resource and any other computing resource of the plurality of computing resources for which an address of the last pointer is in a spare pointer list of the second computing resource.

In some examples, to determine dependencies between the first computing resource and the plurality of computing resources, the semaphore may also set each spare pointer of the first computing resource as identified in a spare pointer list of the first computing resource to an in-play status.

In some examples, to determine dependencies between the first computing resource and the plurality of computing resources, the semaphore also sets a one-way dependency from any other computing resource of the plurality of computing resources on the first computing resource responsive to the other computing resource writing to a last pointer having an address indicated as in-play for the first computing resource.

In some examples, to determine dependencies between the first computing resource and the plurality of computing resources, the semaphore also sets two-way dependency between any pair of computing resources of the plurality of computing resources which have written to their respective last pointers.

In some examples, to determine dependencies between the first computing resource and the plurality of computing resources, the semaphore can determine whether the first computing resource has a dependency on a second computing resource which has been granted access to write to the spare pointer of the shared resource comprises determining whether the spare pointer is included in a first spare pointer list of the first computing resource and in a second spare pointer list of the second computing resource.

At operation 1004, responsive to a request from the first computing resource to access a shared resource, the semaphore determines whether the first computing resource has a dependency on a second computing resource of the plurality of computing resources that has been granted access to write to a spare pointer of the shared resource. In some examples, the first computing resource requests access to the shared resource by writing to a last pointer of the first computing device (e.g., writing to a predefined memory location programmed to indicate the first computing resource's request for access to the shared resource).

At operation 1006, responsive to the first computing resource not having a dependency on the second computing resource, the semaphore grants access to the first computing resource to write to the shared resource at a spare pointer allocated to the first computing resource. For example, granting access to the first computing resource to write to the shared resource may include the semaphore writing to a lock status register (or grant status register) a status of a grant of access to the shared resource for the first computing resource by setting a bit in a lock status register corresponding to the first computing resource and the shared resource to which the first computing resource has been granted access (e.g., given a lock). The writing may enable the first computing resource to poll the lock status register to determine whether the first computing resource has been granted access to the shared resource.

At operation 1008, responsive to the first computing resource having the dependency on the second computing resource, the semaphore denies by the first computing resource to the shared resource. For example, the semaphore may deny access to the first computing resource by clearing (or not setting) a bit in a lock status register corresponding to the first computing resource and any shared resource. The first computing resource may poll the lock status register to determine whether the first computing resource has been granted a lock (e.g., access to) a shared resource, thereby learning in the absence of a set bit in the lock status register that the first computing device has not been granted access to the shared resource.

Although not shown in FIG. 10, in some examples, the method 1000 also includes, responsive to the first computing resource clearing a memory location corresponding to a last pointer allocated to the first computing resource, the semaphore releasing the spare pointer allocated to the first computing resource. In some examples, to release the spare pointer allocated to the first computing resource, the semaphore can clear dependencies determined responsive to the first computing resource having been granted access to the shared resource. Although also not shown in FIG. 10, in some examples, the method 1000 also includes, responsive to clearing the dependencies determined responsive to the first computing resource having been granted access to the shared resource, the semaphore determining whether any other computing resource is eligible to receive a second granted access to access the shared resource.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. A circuit, comprising:
a shared resource; and
a semaphore manager configured to manage access to the shared resource by:
responsive to a first computing resource writing to a last pointer allocated to the first computing resource, determining whether the first computing resource has a dependency on a second computing resource that has been granted access to the shared resource, wherein a spare pointer of the shared resources references a memory address of the shared resource;
responsive to the first computing resource not having a dependency on the second computing resource, granting access by the first computing resource to the shared resource; and
responsive to the first computing resource having the dependency on the second computing resource, denying access by the first computing resource to the shared resource.

2. The circuit of claim 1, wherein to determine dependencies of the first computing resource, the semaphore manager is configured to:
set two-way dependencies between any pair of computing resources that have spare pointers in common; and
set a one-way dependency of the first computing resource on any other computing resource that has a last pointer matching a spare pointer of the first computing resource.

3. The circuit of claim 2, wherein to determine dependencies of the first computing resource, the semaphore manager is configured to set two-way dependencies between the first computing resource and any other computing resource for which an address of the last pointer is in a spare pointer list of the other computing resource.

4. The circuit of claim 3, wherein to determine dependencies of the first computing resource, the semaphore manager is configured to set each spare pointer of the first computing resource as identified in a spare pointer list of the first computing resource to an in-play status.

5. The circuit of claim 4, wherein to determine dependencies of the first computing resource, the semaphore manager is configured to set a one-way dependency from any other computing resource on the first computing resource responsive to the other computing resource writing to a last pointer having an address indicated as in-play for the first computing resource.

6. The circuit of claim 5, wherein to determine dependencies of the first computing resource, the semaphore manager is configured to set two-way dependency between any pair of computing resources which have written to their respective last pointers.

7. The circuit of claim 6, wherein the first computing resource is configured to poll a lock status register to determine whether the first computing resource has been granted access to the shared resource and, responsive to the first computing resource being granted access to the shared resource, to which spare pointer the first computing resource is allocated in the shared resource.

8. The circuit of claim 1, wherein determining whether the first computing resource has a dependency on a second computing resource which has been granted access to write to the spare pointer of the shared resource comprises determining whether the spare pointer is included in a first spare pointer list of the first computing resource and in a second spare pointer list of the second computing resource.

9. The circuit of claim 1, wherein responsive to the first computing resource clearing a memory location corresponding to the last pointer, the semaphore manager is configured to release the spare pointer allocated to the first computing resource.

10. A method, comprising:
determining dependencies between a first computing resource and a plurality of computing resources;
responsive to a request from the first computing resource to access a shared resource, determining whether the first computing resource has a dependency on a second computing resource of the plurality of computing resources that has been granted access to write to the shared resource;
responsive to the first computing resource not having a dependency on the second computing resource, granting access by the first computing resource to write to the shared resource; and
responsive to the first computing resource having the dependency on the second computing resource, denying access by the first computing resource to the shared resource.

11. The method of claim 10, wherein to determine dependencies between the first computing resource and the plurality of computing resources, the method comprises:
setting two-way dependencies between any pair of computing resources that have spare pointers in common; and
setting a one-way dependency of the first computing resource on any other computing resource that has a last pointer matching a spare pointer of the first computing resource.

12. The method of claim 11, wherein to determine dependencies of the first computing resource, the method comprises setting two-way dependencies between the first computing resource and any other computing resource of the plurality of computing resources for which an address of the last pointer is in a spare pointer list of the second computing resource.

13. The method of claim 12, wherein to determine dependencies of the first computing resource, the method comprises setting each spare pointer of the first computing resource as identified in a spare pointer list of the first computing resource to an in-play status.

14. The method of claim 13, wherein to determine dependencies of the first computing resource, method comprises setting a one-way dependency from any other computing resource of the plurality of computing resources on the first computing resource responsive to the other computing resource writing to a last pointer having an address indicated as in-play for the first computing resource.

15. The method of claim 14, wherein to determine dependencies of the first computing resource, the method further comprises setting two-way dependency between any pair of computing resources of the plurality of computing resources which have written to their respective last pointers.

16. The method of claim 15, further comprising writing to a lock status register a status of a grant of access to the shared resource for the first computing resource to enable the first computing resource to poll the lock status register to determine whether the first computing resource has been granted access to the shared resource and, responsive to the first computing resource being granted access to the shared resource, to which spare pointer the first computing resource is allocated in the shared resource.

17. The method of claim 10, wherein determining whether the first computing resource has a dependency on a second computing resource which has been granted access to write to a spare pointer of the shared resource comprises determining whether the spare pointer is included in a first spare pointer list of the first computing resource and in a second spare pointer list of the second computing resource.

18. The method of claim 10, wherein responsive to the first computing resource clearing a memory location corresponding to a last pointer allocated to the first computing resource, the method comprises releasing a spare pointer allocated to the first computing resource.

19. The method of claim 18, wherein to release the spare pointer allocated to the first computing resource, the method comprises clearing dependencies determined responsive to the first computing resource having been granted access to the shared resource.

20. The method of claim 19, further comprising determining whether any other computing resource is eligible to receive a second granted access to access the shared resource responsive to clearing the dependencies determined responsive to the first computing resource having been granted access to the shared resource.
